(19) United States
(12) Patent Application Publication
(10) Pub. No.: US 2023/0172100 A1
(43) Pub. Date: Jun. 8, 2023

(54) WEEDING APPARATUS

(71) Applicant: Alton Toomer, West Babylon, NY (US)

(72) Inventor: Alton Toomer, West Babylon, NY (US)

(21) Appl. No.: 18/076,645

(22) Filed: Dec. 7, 2022

Related U.S. Application Data
(60) Provisional application No. 63/286,746, filed on Dec. 7, 2021.

(51) Int. Cl. A01D 34/01; A01D 34/90

(52) U.S. Cl. CPC A01D 34/015; A01D 34/90

(57) ABSTRACT

A weeding apparatus includes a handle portion coupled to a blade attachment by a boom. The blade attachment is selectively coupled to the boom and includes a blade having a sharpened edge disposed thereon for severing or otherwise cutting weeds and other undesirable plants. The weeding apparatus is drawn across a surface to capture weeds against the blade to sever the weeds without throwing projectiles at nearby structures, vehicles, amongst others.

### CROSS-REFERENCE TO RELATED APPLICATION

The present application claims the benefit of, and priority to, U.S. Provisional Patent Application Ser. No. 63/286,746, filed on Dec. 7, 2021, the entire contents of which is hereby incorporated by reference herein.

### BACKGROUND

### Technical Field

The present disclosure relates to landscaping apparatus, and more particularly, to an apparatus for removing weeds in difficult or hard to reach areas.

### Background of Related Art

Conventional landscaping equipment used for removing weeds or trimming plants are heavy, noisy, cannot be utilized in hard-to-reach places, and can cause projectiles to strike structures, vehicles, or other valuables causing significant damage, such as broken windows, dents, scratches, etc. Apparatus such as string trimmers and lawnmowers can quickly remove weeds and other undesirable plants, but risk throwing rocks or other debris which can damage nearby structures and vehicles. Further, string trimmers and lawnmowers are unable to be used in hard-to-reach places, such as around mechanical equipment (e.g., AC units, transformers), underneath parked vehicles, around vestibules or other structures having glass or that can be easily damaged.

Several methods exist for removing weeds and other undesirable plants in these conditions, such as using one's hands, digging, cutting using shears, hoes, cultivators, etc. However, these methods require one to bend over, be on their hands and knees, cause destruction to the soil, etc. The present disclosure seeks to address these and other shortcomings of prior weeding apparatus and methods.

### SUMMARY

In accordance with an aspect of the present disclosure, a weeding apparatus includes a handle portion defining a first longitudinal axis, an elongate body extending from a distal end of the handle portion and defining a second longitudinal axis, the second longitudinal axis defining a non-parallel angle relative to the first longitudinal axis, an attachment portion extending from a distal end of the elongate body and defining a third longitudinal axis, the third longitudinal axis defining a non-parallel angle relative to the second longitudinal axis, and a blade assembly selectively coupled to the attachment portion, the blade assembly including a housing extending between a proximal end portion and a distal end portion, the housing including a first cavity extending through the proximal end portion, the first cavity configured to selectively receive the attachment portion and selectively couple the housing to the attachment portion, a second cavity defined through the proximal end portion of the housing, and a slot defined through an outer surface of the housing and into the second cavity, the slot extending through the proximal end portion to enable plants to be received within the slot as the blade assembly is translated relative to the plants, and a blade selectively coupled to a portion of the housing that is adjacent to the slot, the blade defining at least one sharpened edge to sever plants received within the slot as the blade assembly is translated relative to the plants.

In aspects, the attachment portion may include a detent mechanism configured to selectively couple the blade assembly to the attachment portion.

In other aspects, the weeding apparatus may include a bode defined through the outer surface of the housing and into the first cavity, the bore configured to selectively revive a portion of the detent mechanism to selectively couple the blade assembly to the attachment portion.

In certain aspects, the housing may define a fourth longitudinal axis, the slot defining a non-parallel angle relative to the fourth longitudinal axis.

In other aspects, the housing may define a fourth longitudinal axis, the slot defining a spiral profile about the fourth longitudinal axis.

In aspects, the slot may define a pair of opposed sidewalls, the pair of opposed sidewalls increasingly approximating one another in a proximal-to-distal direction.

In certain aspects, the blade may be a utility blade.

In aspects, at least one sidewall of the slot may define a groove, the groove configured to receive a portion of the blade and selectively couple the blade to the housing.

In other aspects, the housing may define a frustoconical profile.

In accordance with another aspect of the present disclosure, a weeding apparatus includes a boom including a center portion extending between a handle portion and an attachment portion, the handle portion defining a first angle relative to the center portion and the attachment portion defining a second angle relative to the center portion, and a blade assembly selectively coupled to the attachment portion of the boom, the blade assembly including a housing defining a frustoconical profile, and a blade selectively coupled to a portion of the housing, the blade defining at least one sharpened edge configured to sever plants as the blade assembly is translated relative to the plants.

In aspects, the handle portion may define a first longitudinal axis and the attachment portion defines a second longitudinal axis, wherein the first longitudinal axis is parallel to the second longitudinal axis.

In certain aspects, an outer dimension of the handle may decrease in a proximal-to-distal direction.

In other aspects, the handle portion may include a cavity, the cavity extending through a proximal end portion of the handle and configured to receive and store at least one blade.

In certain aspects, the housing may define a cavity, the cavity extending through a proximal end portion of the housing and configured to selectively retain plants severed by the blade as the blade assembly is translated relative to the plants.

In aspects, a detent mechanism may be disposed on a portion of the attachment portion, the detent mechanism configured to selectively engage a portion of the housing of the blade assembly to selectively couple the blade assembly to the boom.

In accordance with another aspect of the present disclosure, a weeding apparatus includes a boom extending between a proximal end portion and a distal end portion, a detent mechanism disposed on the distal end portion, and a blade assembly selectively coupled to the distal end portion of the boom, the blade assembly including a housing extending between a proximal end portion and a distal end portion and defining a longitudinal axis, the housing including a first cavity extending through the proximal end portion of the housing, the first cavity configured to selectively receive the distal portion of the boom, a bore defined through an outer surface of the housing and extending into the first cavity, the bore configured to receive a portion of the detent mechanism and selectively couple the blade assembly to the boom, a second cavity defined through the proximal end portion of the housing, and a slot defined through the outer surface of the housing and into the second cavity, the slot extending through the proximal end portion of the housing and defining a non-parallel angle relative to the longitudinal axis of the housing, and a blade selectively coupled to a portion of the slot, the blade defining at least one sharpened edge to sever plants received within the slot as the blade assembly is translated relative to the plants.

In aspects, the slot may define a pair of opposed side surfaces, the pair of opposed side surfaces increasingly approximating one another in a proximal-to-distal direction.

In other aspects, the slot may define a pair of opposed side surfaces, at least one of the pair of opposed side surfaces defining a groove for receipt of a portion of the blade.

In certain aspects, the housing may define a frustoconical profile.

In other aspects, the second cavity may include an interior dimension for receiving and storing plants severed by the blade as the blade assembly is translated relative to the plants.

### BRIEF DESCRIPTION OF THE DRAWINGS

Various aspects and features of the present disclosure are described hereinbelow with references to the drawings, wherein:

FIG. 1 is a perspective view of a weeding apparatus provided in accordance with the present disclosure;

FIG. 2 is an elevation view of the weeding apparatus of FIG. 1;

FIG. 3 is an elevation view of a boom of the weeding apparatus of FIG. 1;

FIG. 4 is a perspective view of a handle portion of the boom of FIG. 3;

FIG. 5 is a side view of a cap of the boom of FIG. 3;

FIG. 6 is a perspective view of a blade assembly of the weeding apparatus of FIG. 1;

FIG. 7 is a bottom view of the blade assembly of FIG. 6;

FIG. 8 is an end view of the blade assembly of FIG. 6; and

FIG. 9 is an end, cross-sectional view, of the blade assembly of FIG. 6.

### DETAILED DESCRIPTION

The present disclosure is directed to a weeding apparatus that enables a user to remove weeds or other undesirable plants in hard-to-reach places or proximate object and/or structures that can be easily damaged. In this manner, the weeding apparatus described herein enables a user to reach under vehicles, remove weeds around buildings or other vehicles, etc. without requiring the user to disturb the soil and throw projectiles (e.g., rocks, debris, etc.) towards buildings, cars, etc.

The weeding apparatus includes a handle portion coupled to a blade assembly by a boom. The blade assembly is selectively coupled to the boom and includes a blade having a sharpened edge disposed thereon for severing or otherwise cutting weeds and other undesirable plants. The handle portion and the blade assembly are disposed in a generally parallel arrangement with the boom extending therebetween such that a user may grasp the handle portion and place the blade assembly in a generally parallel orientation relative to the ground. The handle portion may include a storage cavity defined therein for storing extra blades or in embodiments, a sharpening device, which can be selectively closed with a cap or other suitable device.

The blade assembly is selectively coupled to an attachment portion of the boom via a detent or other suitable coupling mechanism that is capable of selectively retaining the blade assembly thereto. The blade assembly includes a slot defined therein which includes a blade having a sharpened edge selectively coupled thereto. The slot, and thereby the blade, may be oriented at an angle relative a longitudinal axis, and in embodiments, may define a V-shaped profile to capture or otherwise compress weeds or other plants captured within the slot against the sharpened edge of the blade. It is envisioned that the blade may be removed from the blade attachment to be sharpened by the sharpening device or replaced altogether with a replacement blade. In this manner, the blade may be slidably received within a groove formed within the slot and retained therein using a locking mechanism, such as a resilient finger, detent, fastener, amongst others.

The weeding apparatus is utilized by grasping the handle portion and placing the blade assembly in a generally parallel orientation relative to a surface having weeds or other undesirable plants. The handle portion is pulled or drawn in a first direction such that the blade assembly is likewise caused to be drawn across the surface such that weeds are received or otherwise captured within the slot. Continued drawing of the handle portion causes the weeds received within the slot to contact the sharpened edge of the blade and be severed. The severed portions of the weeds can be captured within a cavity formed within the blade assembly and be disposed of when the weeding apparatus is done being used. These and other aspects of the present disclosure will be described in detail herein below with reference to the drawings.

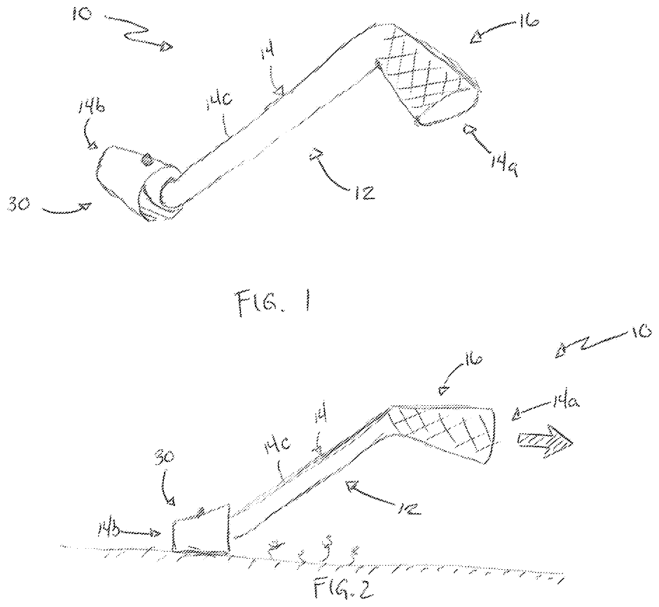

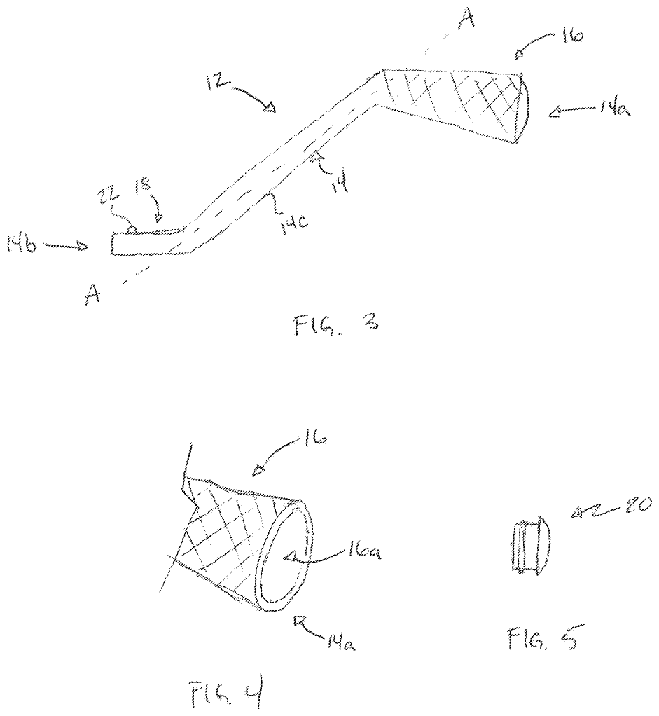

Turning now to the drawings, FIGS. 1-5 illustrate a weeding apparatus provide in accordance with the present disclosure and generally identified by reference numeral 10. The weeding apparatus 10 includes a handle or boom 12 and a blade assembly 30 operably coupled to the boom 12. The boom 12 defines an elongate body 14 extending between a proximal end portion 14a and a distal end portion 14b. The elongate body 14 includes a center portion 14c is bounded by a handle portion 16 disposed adjacent the proximal end portion 14a and an attachment portion 18 (FIG. 3) disposed adjacent the distal end portion 14b. In this manner, the center portion 14c is a transversal interposed between, and intersecting, each of the handle portion 16 and the attachment portion 18.

The center portion 14c of the boom 12 defines a generally circular cross-sectional profile, although it is envisioned that the center portion 14c may include any suitable cross-sectional profile, such as square, oval, elliptical, hexagonal, amongst others, depending upon the design needs of the weeding apparatus 10. The center portion 14c defines a generally linear profile extending along a longitudinal axis A-A (FIG. 3) defined through the center portion 14c. Although generally described as being linear, it is contemplated that the center portion 14 may be arcuate, partially linear, curvilinear, or include any suitable profile along the longitudinal axis A-A.

The handle portion 16 extends from the center portion 14c and terminates at the proximal end portion 14a. The handle portion 16 forms an angle relative to the longitudinal axis A-A to aid in grasping and to plate the attachment portion 18 at an orientation relative to a surface that enables a user to drag the weeding apparatus 10 along the ground and sever or otherwise cut weeds at the surface of the ground (FIG. 2). In embodiments, the handle portion 16 and the attachment portion 18 are disposed in a parallel orientation relative to one another, in which the center portion 14c forms a transversal having consecutive angles that are generally supplementary, although it is envisioned that the handle portion 16 and the attachment portion 18 may be orientated at any suitable angle relative to one another, and may form the same or different angle relative to the center portion 14c depending upon the design needs of the weeding apparatus 10.

It is envisioned that the handle portion 16 may include any suitable cross-sectional profile, and in embodiments, may be circular, oval, elliptical, hexagonal, amongst others, and may maintain a constant profile from the center portion 14c to the proximal end portion 14a. In one non-limiting embodiment, the handle portion 16 defines an elliptical profile having a greater dimension in a vertical direction (e.g., a plane intersecting the ground at a perpendicular angle when the weeding apparatus 10 is grasped by a user) and flares or otherwise increases in a vertical dimension in a direction extending from the center portion 14c toward the proximal end portion 14a. As can be appreciated, the flare of the handle portion 16 aids a user in grasping the handle portion 16 and inhibits the handle portion 16 from being pulled from the user's hand when the user is utilizing the weeding apparatus 10. In embodiments, the handle portion 16 may include one or more crenellations, protuberances, indentations, knurling, amongst others, and in one non-limiting embodiment, may include a plurality of protuberances configured to be interposed between or otherwise engage a user's fingers.

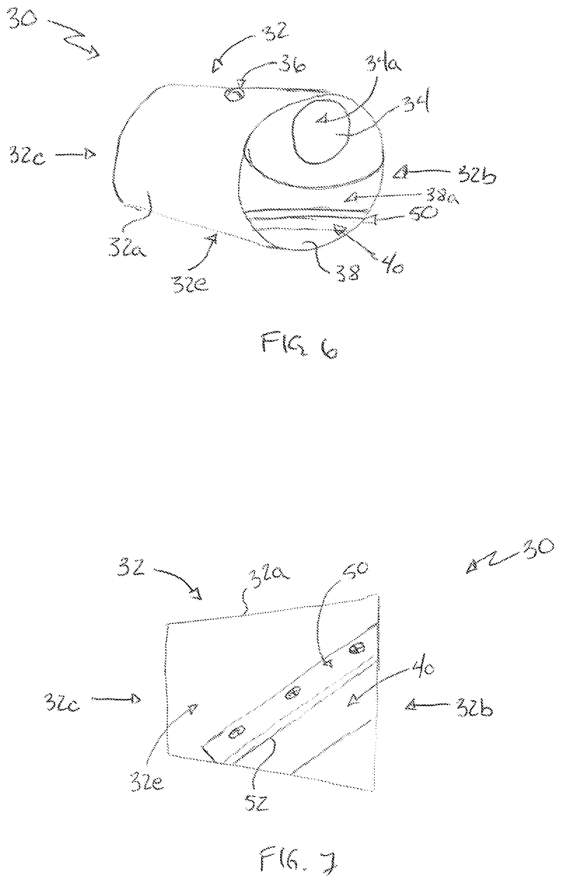

The handle portion 16 includes a cavity 16a (FIG. 4) defined therein extending through the proximal end portion 14a. The cavity 16a is configured to receive or otherwise store extra blades, tools, sharpeners, or other devices for convenient access by the user. A cap or cover 20 (FIG. 5) is configured to selectively cover the cavity 16a to inhibit ingress of dust, water, fingers, etc. and inhibit the components stored within the cavity 16a from inadvertently falling out. It is envisioned that the cap 20 may include any suitable profile and may be the same or different from the profile of the handle portion 16. In embodiments, the cap 20 may be disposed over the proximal end portion 14a or at least a portion of the cap 20 may be received within the cavity 16a. It is contemplated that the cap 20 may be selectively coupled to the handle portion 16 using any suitable means, such as friction fit, detents, hook and loop, amongst others.

The attachment portion 18 defines a generally linear profile extending from the center portion 14c to the distal end portion 14b. The attachment portion 18 defines a circular cross-section that may be the same or different than the cross-sectional profile of the center portion 14c, although it is envisioned that the attachment portion 18 may include any suitable cross-sectional profile, such as rectangular, oval, elliptical, hexagonal, amongst others. The attachment portion 18 includes a detent or button 22 disposed thereon that extends radially outward from an outer surface of the attachment portion 18. In this manner, the detent 22 may be disposed within a bore or other suitable feature formed within the attachment portion 18. The detent 22 is configured to engage a corresponding feature on the blade assembly 30 to selectively couple the blade assembly 30 to the attachment portion 18, as will be described in further detail hereinbelow. It is envisioned that the detent 22 may be a button spring clip, a ball detent (e.g., ball-nose spring plunger), amongst others. Although generally described as being a detent, it is envisioned that the detent 22 may be any suitable fastener, such as a screw, push in rivet, rivet, amongst others.

It is envisioned that the boom 12 may be formed from any suitable material, such as a metallic material (steel, aluminum, etc.), a non-metallic material (plastic, rubber, etc.), composites (carbon fiber, fiberglass, etc.), wood, amongst others, or combinations thereof. In embodiments, the boom 12 may be formed from a continuous piece of material by bending, molding, hydroforming, extrusion, amongst others or may be formed from multiple pieces of material coupled to one another by welding, adhesives, fasteners, press fit, friction fit, amongst others, depending upon the design needs of the weeding apparatus 10. It is further envisioned that the boom 12 may be formed form a hollow material, a solid material, or combinations thereof.

With reference to FIGS. 6-9, the blade assembly 30 includes a housing 32 and a blade 50 selectively coupled to a portion of the housing 32. The housing 32 defines a generally conical frustum profile having an outer surface 32a extending between opposed proximal and distal end portions 32b and 32c, respectively. Although generally described as having a conical frustum profile, it is envisioned that the housing 32 may include any suitable profile, such as circular, oval, elliptical, square, hexagonal, amongst others. In one non-limiting embodiment, a lower portion 32d of the housing 32 includes an angle that is generally parallel attachment portion 18 of the boom 12 to aid in placing the lower portion 32d of the housing 32 generally parallel with the ground. In embodiments where the attachment portion 18 of the boom 12 is not placed parallel with the ground, the lower portion 32d may form an angle relative to the attachment portion 18 such that when the handle portion 16 is grasped and placed proximate to the ground, the lower portion 32d forms a generally parallel angle relative to the ground. It is envisioned that the housing 32 may be formed from any suitable material, such as a metallic material, non-metallic material, composite, amongst others, or combinations thereof.

The housing 32 defines a first inner surface 34 defining a cavity 34a extending through the proximal end portion 32b. The cavity 34a is disposed adjacent the outer surface 32a (e.g., offset from a center axis of the housing 32) and includes an inner dimension that is configured to selectively receive a portion of the attachment portion 18 of the boom 12. A detent bore 36 is defined through the outer surface 32a and the first inner surface 34 for selective receipt of the detent 22 of the attachment portion 18 when the attachment portion 18 is received within the cavity 34a to selectively couple the blade assembly 30 to the attachment portion 18. Although generally described as being disposed adjacent the outer surface 32a, it is envisioned that the cavity 34a may be disposed at any suitable location within the housing 32.

The housing 32 defines a second inner surface 38 defining a second cavity 38a extending through the proximal end portion 32b. A slot 40 is defined through the second inner surface 38 and the outer surface 32a and extends through the proximal end portion 32b. In this manner, the slot 40 extends along a longitudinal axis defined through the housing 32 and is configured to receive a portion of weeds or other plants, etc. therein. It is envisioned that the slot 40 may be oriented at perpendicular angle relative to the proximal end portion 32b, may be oriented at an angle relative to the proximal end portion 32b, may be disposed in a spiral fashion, etc. In one non-limiting embodiment, the slot 40 is oriented at an angle relative to the proximal end portion 32b such that as weeds enter the slot 40 as the weeding apparatus 10 is drawn across the ground, the weeds are caused to abut or otherwise contact a wall of the slot 40. In this manner, it is contemplated that the slot 40 may define a generally V-shaped profile, such that an acute angle is formed at a distal portion of the slot 40 to trap or otherwise compress weeds disposed within the slot 40. In embodiments, the slot 40 may include a groove 42 (FIG. 9) or other suitable feature for slidably receiving a portion of the blade 50 therein and selectively retaining the blade 50 within the housing 32. It is envisioned that the housing 32 may include an aperture 44 (FIG. 8) defined through the distal end portion 32c and generally aligned with the slot 40 to receive the blade 50 therethrough. In this manner, a user may load or remove a blade 50 from the housing by advancing or retracting the blade 50 through the aperture 44. In embodiments, the blade 50 may be selectively retained within the slot via a resilient finger, detent, fasteners, hook and loop, adhesives, amongst others.

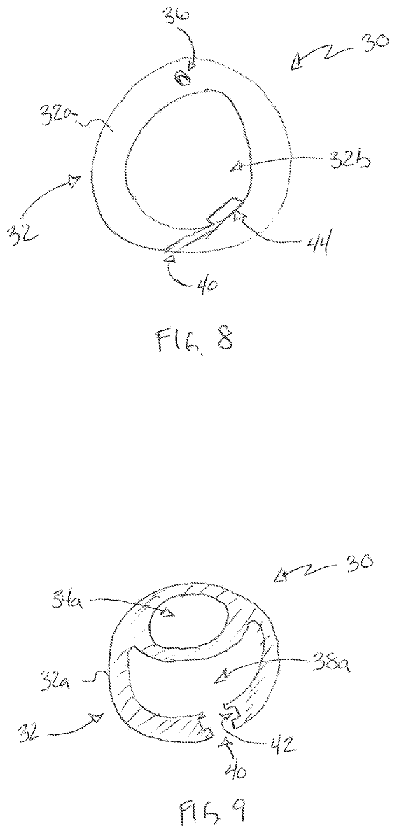

The blade 50 defines a generally planar profile having at least one sharpened edge 52 extending longitudinally along a length of the blade 50 (FIG. 7). Although generally described as being planar, it is envisioned that the blade 50 may define any suitable profile, such as arcuate, and the sharpened edge 52 may be linear, arcuate, curvilinear, amongst others. In one non-limiting embodiment, the blade 50 may be a conventional utility blade (e.g., a box cutter). It is contemplated that the blade 50 may be formed from any suitable material, such as carbon steel, stainless steel, high carbon steel, titanium, ceramic, plastic, amongst others, and may be coated with any suitable coating such as titanium nitride, amongst others.

The sharpened edge 52 of the blade 50 is configured to abut or otherwise contact weeds or other plants received within the slot 40 and second cavity 38a. As the weeding apparatus 10 is drawn across the ground, the weeds or plants contacting the sharpened edge 52 are severed or otherwise cut. In embodiments, where the slot 40 defines a V-shaped profile, as the weeds are captured in the acute angle or apex of the slot, the weeds are compressed against the wall of the slot 40 and the sharpened edge 52 of the blade 50, aiding in the cutting or severing of the weeds as the weeding apparatus 10 is drawn across the ground. As can be appreciated, the second cavity 38a of the housing 32 can capture or otherwise receive a portion of the weeds severed by the sharpened edge 52 for storage until the user empties or otherwise dumps the contents of the second cavity 38a into a suitable location.

In embodiments, the weeding apparatus 10 may include a sharpening device (not shown) that is configured to sharpen or otherwise restore the sharpened edge 52 of the blade 50. It is contemplated that the sharpening device may sharpen the sharpened edge 52 while the blade 50 remains coupled to the housing 32 or may be utilized when the blade 50 is removed from the housing 32. In embodiments, the sharpening device may be stored within the cavity 16a of the handle portion 16 or may be selectively coupled to a portion of the boom 12 using any suitable means, such as fasteners, hook and loop, resilient fingers, buttons, amongst others.

In operation, the handle portion 16 of the weeding apparatus 10 is grasped and the housing 32 of the blade assembly 30 is oriented proximate a surface having weeds or other undesirable plants. The housing 32 is angled generally parallel to the surface, at which point the handle portion 16 is drawn or otherwise pulled such that the housing 32 is caused to be drawn across the surface. Continued drawing of the housing 32 across the surface causes weeds or other plants to be received within the slot 40 of the housing 32 and abut the sharpened edge 52 of the blade 50. Further drawing of the housing 32 across the surface causes the sharpened edge 52 of the blade 50 to sever or otherwise cut the weeds caught within the slot 40. Once the weeds are cut, at least some of the severed portions of the weeds are captured within the second cavity 38a of the housing 32, which can then be disposed of in a suitable receptacle or suitable location. To aid disposing of the contents of the second cavity 38a, the blade assembly 30 may be removed from the attachment portion 18 of the boom 12 by depressing the detent 22. Once the contents of the second cavity 38a are disposed of, the blade assembly 30 may be recoupled to the attachment portion 18 by inserting the attachment portion 18 into the cavity 34a until the detent 22 is received within the detent bore 36 of the housing 32.

If the sharpened edge 52 of the blade 50 become dull or is damaged, the blade 50 may be replaced or sharpened. To replace the blade 50, the blade 50 the locking mechanism (not shown) is disengaged to allow the blade 50 to be slide out from the slot 40. The cap 20 is removed to enable access to the cavity 16a of the handle portion 16 in which replacement blades may be stored. Once a new blade is retrieved from the cavity 16a, the cap 20 is replaced and the new blade is inserted into the aperture 44 of the housing 32 and advanced into the slot 40 until the blade 50 is fully received within the slot 40 and the locking mechanism is engaged to retain the blade 50 within the slot 40. Sharpening the sharpened edge 52 of the blade may be performed by removing the blade 50 using a similar procedure as described hereinabove. Additionally, it is envisioned that the sharpened edge 52 of the blade 50 may be repaired while the blade 50 is disposed within the slot 40 by drawing or otherwise sliding the sharpening device (not shown) across the sharpened edge 52.

As can be appreciated, the use of the weeding apparatus 10 to remove weeds or other undesirable plants from a landscape avoids throwing rocks or other debris towards structures, vehicles, or other valuables. This is in contrast to other devices utilized to remove weeds, such as string trimmers, lawnmowers, etc., which can throw or otherwise launch projectiles which can break glass, dent vehicles, scratch paint, etc. Further, the weeding apparatus 10 can easily reach under cars, mechanical devices, or other encumbrances where string trimmers or lawnmowers are unable to reach. The weeding apparatus 10 described herein easily and quickly removes weeds in a non-destructive manner, avoiding the above-mentioned issues attributed to conventional weeding apparatus.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments.

As used in the drawings and in the description hereinabove, terms such as front, rear, upper, lower, top, bottom, and similar directional terms are used simply for convenience of description and are not intended to limit the disclosure. As used herein, the term proximal refers to a location that is closer to a user and the term distal refers to a location that is further from a user. In the description hereinabove, well-known functions or constructions are not described in detail to avoid obscuring the present disclosure in unnecessary detail.

What is claimed is:

1. A weeding apparatus, comprising:
a handle portion defining a first longitudinal axis;
an elongate body extending from a distal end of the handle portion and defining a second longitudinal axis, the second longitudinal axis defining a non-parallel angle relative to the first longitudinal axis;
an attachment portion extending from a distal end of the elongate body and defining a third longitudinal axis, the third longitudinal axis defining a non-parallel angle relative to the second longitudinal axis; and
a blade assembly selectively coupled to the attachment portion, the blade assembly including:
a housing extending between a proximal end portion and a distal end portion, the housing including:
a first cavity extending through the proximal end portion, the first cavity configured to selectively receive the attachment portion and selectively couple the housing to the attachment portion;
a second cavity defined through the proximal end portion of the housing; and
a slot defined through an outer surface of the housing and into the second cavity, the slot extending through the proximal end portion to enable plants to be received within the slot as the blade assembly is translated relative to the plants; and
a blade selectively coupled to a portion of the housing that is adjacent to the slot, the blade defining at least one sharpened edge to sever plants received within the slot as the blade assembly is translated relative to the plants.

2. The weeding apparatus according to claim 1, wherein the attachment portion includes a detent mechanism configured to selectively couple the blade assembly to the attachment portion.

3. The weeding apparatus according to claim 2, wherein a bore is defined through the outer surface of the housing and into the first cavity, the bore configured to selectively receive a portion of the detent mechanism to selectively couple the blade assembly to the attachment portion.

4. The weeding apparatus according to claim 1, wherein the housing defines a fourth longitudinal axis, the slot defining a non-parallel angle relative to the fourth longitudinal axis.

5. The weeding apparatus according to claim 1, wherein the housing defines a fourth longitudinal axis, the slot defining a spiral profile about the fourth longitudinal axis.

6. The weeding apparatus according to claim 1, wherein the slot defines a pair of opposed sidewalls, the pair of opposed sidewalls increasingly approximating one another in a proximal-to-distal direction.

7. The weeding apparatus according to claim 1, wherein the blade is a utility blade.

8. The weeding apparatus according to claim 1, wherein at least one sidewall of the slot defines a groove, the groove configured to receive a portion of the blade and selectively couple the blade to the housing.

9. The weeding apparatus according to claim 1, wherein the housing defines a frustoconical profile.

10. A weeding apparatus, comprising:
a boom, the boom including:
a center portion extending between a handle portion and an attachment portion, the handle portion defining a first angle relative to the center portion and the attachment portion defining a second angle relative to the center portion; and
a blade assembly selectively coupled to the attachment portion of the boom, the blade assembly including:
a housing defining a frustoconical profile; and
a blade selectively coupled to a portion of the housing, the blade defining at least one sharpened edge configured to sever plants as the blade assembly is translated relative to the plants.

11. The weeding apparatus according to claim 10, wherein the handle portion defines a first longitudinal axis and the attachment portion defines a second longitudinal axis, wherein the first longitudinal axis is parallel to the second longitudinal axis.

12. The weeding apparatus according to claim 10, wherein an outer dimension of the handle decreases in a proximal-to-distal direction.

13. The weeding apparatus according to claim 10, wherein the handle portion includes a cavity, the cavity extending through a proximal end portion of the handle and configured to receive and store at least one blade.

14. The weeding apparatus according to claim 10, wherein the housing defines a cavity, the cavity extending through a proximal end portion of the housing and configured to selectively retain plants severed by the blade as the blade assembly is translated relative to the plants.

15. The weeding apparatus according to claim 10, wherein a detent mechanism is disposed on a portion of the attachment portion, the detent mechanism configured to selectively engage a portion of the housing of the blade assembly to selectively couple the blade assembly to the boom.

16. A weeding apparatus, comprising:
a boom extending between a proximal end portion and a distal end portion;
a detent mechanism disposed on the distal end portion; and
a blade assembly selectively coupled to the distal end portion of the boom, the blade assembly including:
a housing extending between a proximal end portion and a distal end portion and defining a longitudinal axis, the housing including:
a first cavity extending through the proximal end portion of the housing, the first cavity configured to selectively receive the distal portion of the boom;
a bore defined through an outer surface of the housing and extending into the first cavity, the bore configured to receive a portion of the detent mechanism and selectively couple the blade assembly to the boom;
a second cavity defined through the proximal end portion of the housing; and
a slot defined through the outer surface of the housing and into the second cavity, the slot extending through the proximal end portion of the housing and defining a non-parallel angle relative to the longitudinal axis of the housing; and
a blade selectively coupled to a portion of the slot, the blade defining at least one sharpened edge to sever plants received within the slot as the blade assembly is translated relative to the plants.

17. The weeding apparatus according to claim 16, wherein the slot defines a pair of opposed side surfaces, the pair of opposed side surfaces increasingly approximating one another in a proximal-to-distal direction.

18. The weeding apparatus according to claim 16, wherein the slot defines a pair of opposed side surfaces, at least one of the pair of opposed side surfaces defining a groove for receipt of a portion of the blade.

19. The weeding apparatus according to claim 16, wherein the housing defines a frustoconical profile.

20. The weeding apparatus according to claim 16, wherein the second cavity includes an interior dimension for receiving and storing plants severed by the blade as the blade assembly is translated relative to the plants.
